(19) United States
(12) Patent Application Publication
(10) Pub. No.: US 2006/0293401 A1
(43) Pub. Date: Dec. 28, 2006

(54) Cartridge foam insert for foam generating and injecting apparatus

(75) Inventor: Richard A. Porter, Knoxville, TN (US)

Correspondence Address: MICHAEL E. MCKEE;Attorney at Law, 804 Swaps Lane, Knoxville, TN, 37923, US

(73) Assignee: Core Foam, Inc.

(21) Appl. No.: 11/158,809

(22) Filed: Jun. 22, 2005

(51) Int. Cl. C08G 18/00

(52) U.S. Cl. 521/172

(57) ABSTRACT

A filler material in the form of a cartridge insert is positionable within an apparatus for generating and injecting a foamed polymeric resin formed by the mixture of a plurality of foam-producing ingredients wherein the apparatus includes an elongate foaming chamber having an interior through which two mixable foam-producing ingredients are conducted. The filler material includes a body of polyurethane foam which is adapted to be accepted by and substantially fill the interior of the foaming chamber for enhancing the blend of the mixable foam-producing ingredients as the mixable foam-producing ingredients are conducted through the foaming chamber. Preferably, the polyurethane foam of the body is a polyether polyurethane foam, possesses an Indentation Force Deflection value which is at least as great as 30 pounds per 50 square inches (30 lbs/50 in²) and possesses a density which is between within the range of between 1.0 lbs/ft³ and 5.0 lbs/ft³.

### BACKGROUND OF THE INVENTION

This invention relates generally to apparatus for generating and injecting a foamed polymeric resin produced with foam-producing ingredients delivered to the apparatus and relates, more particularly, to componentry within such apparatus for enhancing the blend of foam-producing ingredients with one another as the foam-producing ingredients are conducted through the apparatus. Foamed polymeric resins have been found to be particularly well-suited for use as a thermal and/or acoustical insulation.

The apparatus with which this invention is concerned is in the form of an elongated spray gun having a manifold section at one of the gun through which foam-producing ingredients are introduced to the gun and a nozzle section at the opposite end of the gun through which the generated foam is discharged from the gun. The foam-producing ingredients used to generate a foam within the gun include a liquid solution of resin, a liquid solution of foaming catalyst and a compressed gas (e.g. air), and each ingredient is introduced to the gun through the manifold section thereof and forced to flow toward the opposite, nozzle, end of the gun. A central conduit is supported along the length of the gun for conducting the resin solution toward the nozzle end of the gun, and a foaming chamber, disposed coaxially with the central conduit, transports the foaming catalyst and gas toward the nozzle end of the gun. The foaming catalyst and gas are permitted to mix with one another as they move through the foaming chamber so that upon reaching the nozzle end of the gun, the mixture of foaming catalyst and gas is, in turn, permitted to mix with the resin solution to form the desired resin foam. An example of a spray gun having the aforedescribed characteristics is shown and described in U.S. Pat. No. 4,213,936, the disclosure of which is incorporated herein by reference.

To assist in the mixing of the foaming catalyst and gas (e.g. air) together as these ingredients flow through the foaming chamber, a filler material—which can take the form of glass beads or metal wool—is commonly positioned within the foaming chamber. In practice, this filler material provides surface area which helps to agitate the flow of foaming catalyst and gas as these ingredients move through the foaming chamber to increase the exposure of the foaming catalyst and gas to one another. When the foaming catalyst and gas are adequately mixed with one another, the resulting mixture possesses the consistency of a foamy, or frothy, substance comprised of substantially spherical bubbles of gas surrounded by a film layer of liquid foaming catalyst.

Heretofore, filler material used within the foaming chamber of a spray gun has been limited in that it is either comprised of loose items (e.g. glass beads) or is comprised of compressible material (e.g. steel wool) which is susceptible of being packed within the foaming chamber either too tightly or too loosely. If, for example, the filler material is comprised of loose items, such as glass beads, the servicing of the spray gun—which commonly requires an emptying of the foaming chamber—also requires a time-consuming collection and cleaning of the loose items and subsequent re-introduction of the loose items within the foaming chamber. Furthermore, if the filler material is packed too tightly, the material might not permit the desired flow of foaming catalyst and gas through the foaming chamber, and if the filler material is packed too loosely, the material could provide an insufficient amount of surface area to effectively agitate the flow of foaming catalyst and gas through the foaming chamber.

Accordingly, it is an object of the present invention to provide a new and improved filler material which is positionable within the foaming chamber of a spray gun of the aforedescribed class.

Another object of the present invention is to provide such a filler material which facilitates the servicing of the spray gun.

Still another object of the present invention is to provide such a filler material which is in the form of a unitary insert which can be readily positioned within or removed from the spray gun.

Yet another object of the present invention is to provide such a filler material which does not adversely effect the flow of foam-producing ingredients through the foaming chamber yet promotes a uniformity in the mixture of the ingredients as the ingredients flow through the foaming chamber.

A further object of the present invention is to provide such a filler material for positioning within the foaming chamber of a spray gun which is uncomplicated in structure, yet effective in operation.

### SUMMARY OF THE INVENTION

This invention resides in a filler material positionable within an apparatus for generating and injecting a foamed polymeric resin formed by the mixture of a plurality of foam-producing ingredients wherein the apparatus includes an elongate foaming chamber having an interior through which two mixable foam-producing ingredients are conducted.

The filler material includes a body of polyurethane foam which is adapted to be accepted by and substantially fill the interior of the foaming chamber for enhancing the blend of the mixable foam-producing ingredients as the mixable foam-producing ingredients are conducted through the foaming chamber.

### BRIEF DESCRIPTION OF THE DRAWINGS

FIG. 1 is a side elevational view, shown partially in longitudinal cross section, of a spray gun and an embodiment of a filler material insert positioned within the spray gun.

FIG. 2 is a longitudinal cross-sectional view of the nozzle section of the spray gun as seen in FIG. 1 but drawn to a slightly larger scale.

FIG. 3 is a perspective view of the FIG. 1 spray gun shown exploded.

FIG. 4 is an end view of the filler material insert of FIG. 1, as seen from the right in FIG. 1.

### DETAILED DESCRIPTION OF AN ILLUSTRATIVE EMBODIMENT

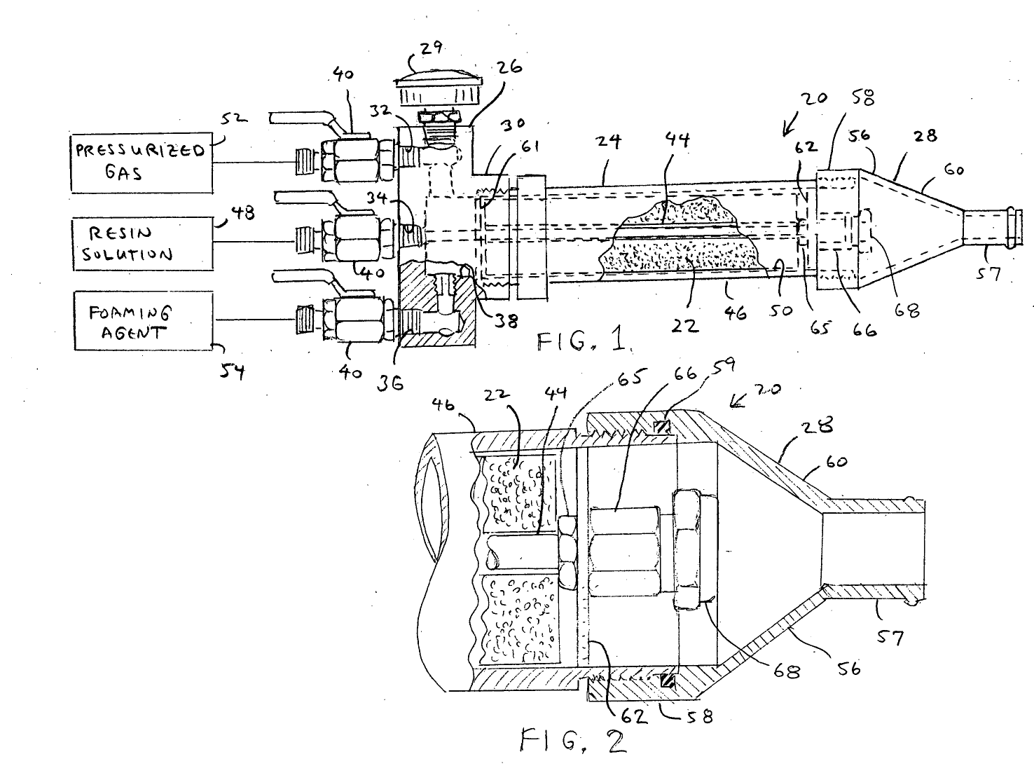

Turning now to the drawings in greater detail and considering first FIG. 1, there is illustrated a foam generating and injecting apparatus (hereinafter referred to as a spray gun), generally indicated 20, and a cartridge foam insert 22 shown positioned within the spray gun 20. The spray gun 20 is adapted to receive three foam-producing ingredients, namely, a pressurized gas (e.g. air), a liquid solution of resin, and a liquid foaming catalyst, used to generate a foamed polymer resin within the gun 20 for discharge from one end thereof. As will be apparent herein, the spray gun 20 includes a foaming chamber within which two of the foam-producing ingredients (i.e. a foaming catalyst and a compressed gas) are mixed together to produce a foamy mixture prior to the introduction of the foamy mixture to the third foam-producing ingredient (i.e. a resin) within the gun 20, and the foam insert 22 is positioned within the foaming chamber to enhance the agitation and subsequent blend of the foaming catalyst and compressed gas. The foam insert 22 is constructed of an open-cell foam material which uniformly agitates the foaming catalyst and gas conducted therethrough and is readily removable when servicing the spray gun 20.

With reference still to FIG. 1, the spray gun 20 includes an elongated body 24 having a manifold section 26 disposed at one end of the gun 20 and a nozzle section 28 disposed at the opposite end of the gun 20. The manifold section 26 includes a head 30 having three passageways 32, 34 and 36 through which the three foam-producing ingredients are delivered to the gun 20 and which open to a hollow interior 38. Furthermore, there are provided three assemblies 40 including nipples and shutoff valves which are each connected to a corresponding passageway 32, 34 or 36 for control of a corresponding foam-producing ingredient delivered to the gun 20. In addition, a meter 29 (which may be an optional component on a comparable spray gun) is joined to the manifold section 26 for monitoring the internal pressure of the hollow interior of the manifold head 30.

One passageway, indicated 34 in FIG. 1, is disposed substantially centrally of the head 30 of the manifold section 26, and there exists a central conduit 44 which is joined at one end to the passageway 34 for accepting the contents conducted therethrough and is supported at its other end adjacent the nozzle section 28. The passageway 34 and conduit 44 are adapted to conduct a liquid resin solution delivered, under pressure, to the gun 20 from a source, indicated 48, of liquid resin solution to the nozzle section 28 where it is mixed with the other two foam-producing ingredients (i.e. the compressed gas and foaming catalyst) to generate the desired resin foam.

The gun 20 further includes a cylindrical tube 46 which is joined to the head 30 of the manifold section 26 so that the interior of the tube 46 is in communication with the hollow interior 38 of the head 30 and so that the two foam-producing ingredients (i.e. compressed gas and foaming catalyst) delivered, respectively, to the gun 20 from a compressed gas source 52 (e.g. an air compressor) and a source 54 of liquid foaming catalyst through the passageways 32 and 36 are forced to flow through the tube 46 toward the nozzle section 28. As the foaming catalyst and gas are directed through the tube 46, the foaming catalyst and gas mix with one another to form a foamy substance comprised of spherical bubbles of gas surrounded by a film layer of liquid foaming catalyst. As will be apparent herein, the foamy substance generated with the mixture of foaming catalyst and gas is forced into the nozzle section 28 where it is mixed with the resin solution exiting the conduit 44 to thereby form the desired foam polymeric resin. It follows that the space provided between the inside wall of the cylindrical tube 46 and the outer wall of the central conduit 44 provide a foaming chamber, indicated 50, for the spray gun 20, and it is within this space, or foaming chamber 50, that the embodiment of the cartridge foam insert 20 is positioned for enhancing the blend of the foaming catalyst and the gas flowing through the foaming chamber 50.

As best shown in FIG. 2, the nozzle section 28 includes a conically-shaped head 56 having a collar portion 58 adapted to threadably accept the discharge end of the cylindrical tube 46 and a tubular discharge portion 57 joined to the collar portion 58 by way of a tapered mid-portion 60. The collar portion 58 is sealed about the discharge end of the tube 46 with either threaded pipe threads (not shown) of an O-ring 59.

Mounted at opposite ends of the central conduit 44 are perforated screens 61, 62 (FIG. 1) which are each captured between threaded pipe bushings, a pair of jam nuts or, as illustrated in FIG. 2, a jam nut 65 and a collar 66 which have been threaded upon the conduit 44 at the ends thereof. Each of the perforated screens 61 and 62 is provided with a plurality of apertures to permit the passage of foaming catalyst and gas (or the foamy mixture of foaming catalyst and gas) therethrough. Collectively and as will be apparent herein, the screens 61, 62 confine the cartridge foam insert 22 in place along the length of the foaming chamber 50.

The discharge end of the conduit 44 terminates at a spray head 68 through which the resin solution is discharged in a spray pattern within the nozzle section 28 for mixing of the resin solution with the foamy substance generated with the foaming catalyst and gas. Although a detailed description of the spray tip 68 and its componentry is not believed to be necessary, suffice it to say that the spray tip 68 includes a metering orifice of a size and shape to provide a hollow cone spray of resin within the mixing chamber for mixing with the foamy mixture of foaming catalyst and gas flowing through the nozzle section 28 so that the desired foamed polymeric resin is discharged through the discharge tube of the nozzle section. For a more complete description of a spray tip suitable for use in the spray gun 20, reference can be had to U.S. Pat. No. 4,213,936, the disclosure of which is incorporated herein by reference.

It is a feature of the cartridge foam insert 22 that it is comprised of a body of reticulated open-cell polymeric foam. When the foam insert 22 is positioned within the foaming chamber 50, the open cells of the insert permit the flow of foaming catalyst and resin through the insert 22 with very little resistance yet promotes uniformity in the mixture of the foaming catalyst and the gas which flows through the foaming chamber 50. Consequently, the insert 22 substantially reduces the likelihood that the foamy substance (i.e. the mixture of foaming catalyst and gas) which reaches the nozzle section 28 of the gun 20 will contain pockets of unmixed foaming catalyst or gas. Accordingly, it follows that the insert 22 promotes the generation of a much more thorough and uniform mixture between the resin which exits the central conduit 44 and the foaming chamber 50 (i.e. the mixture of foaming catalyst and gas) which exits the foaming chamber for forming the resultant foamed polymeric resin.

Although the cell or pore size of the foam of the insert 22 can vary over a relatively broad range, such as, for example, between about ten to fifty pores per inch (ppi), it has been found that a foam insert possessing a pore size of between about twenty and thirty pores per inch (ppi) is suitable for use as the insert 22.

Within the family of polyurethane foams, it is more desirable that the foam be of the polyether polyurethane type as opposed to the polyester polyurethanes due to the higher resistance to degradation from moisture offered by polyether polyurethanes. Further, it has been found that firmer flexible polyurethane foams are preferred over softer flexible polyurethane foams which might be subject to compressing or crushing within the foam chamber. As such, foams with higher Indentation Force Deflection values, or IFD values, are preferred over lower values, preferably greater than 30 pounds per 50 square inches (i.e. 30 lbs/50 in²) and, more preferably, greater than 50 lbs/50 in²) up to the maximum achievable for flexible foams, i.e. those in the range of about 120 lbs/50 in². Moreover, the density of the flexible polyurethane foam can be prescribed as well as being in the range of 1.0 lbs/ft³ up to 5.0 lbs/ft³. Foams possessing a density which is lower than these values degrade too rapidly whereas foams possessing a density which is higher than these values are not economically viable.

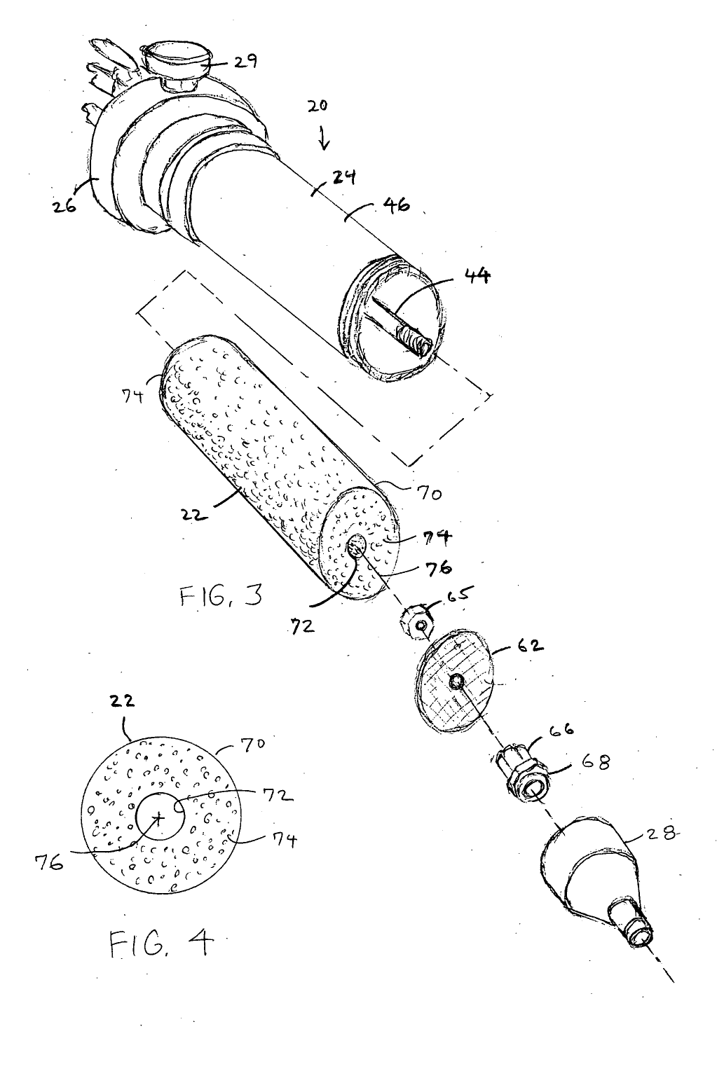

Further still, to increase the likelihood that the foaming catalyst and the gas which flows through the foaming chamber 50 will flow through the body of the insert 22 (rather than flow around the body of the insert 22), the body of the insert 22 possesses a shape and size so that the insert 22 substantially fills the interior of the foaming chamber 50 (and spans the entire cross section of the chamber 50) when the insert 22 is positioned within the chamber 50. To this end, the body of the insert 22 includes a cylindrically-shaped outer surface 70 having an outer diameter which is about the same as, or slightly smaller than, the inner diameter of the outer cylindrically-shaped wall of the foaming chamber 50. To accommodate the central conduit 44 which extends along the center of the foaming chamber 50, the body of the insert 22 includes a central opening 72 which extends along the center of the insert body, and the diameter of the central opening 72 is about the same as, or slightly greater than, the outer diameter of the central conduit 44. The body of the insert 22 has end walls, indicated 74, in FIG. 3 which are planar in shape and which are oriented substantially perpendicular to the longitudinal axis, indicated 76 in FIGS. 3 and 4, of the body of the insert 22.

To position the insert 22 within the foaming chamber 50 and with reference to FIG. 3, the nozzle section 28 is removed (i.e. unscrewed) from the cylindrical tube 46, and then the nozzle head 68, screen 62, and jam nut 65 are removed from the end of the central conduit 44 to expose the interior of the cylindrical tube 46. The cylindrically-shaped insert 22 is then inserted end-first into the cylindrical tube 46 until one end of the insert 22 abuts the screen 61 (FIG. 1) supported within the opposite end of the tube 46. The jam nut 65, screen 62, and nozzle head 68 are then replaced up the central conduit 44, and then the nozzle section 28 is replaced upon the cylindrical tube 46. To remove the insert 22 from its installed position within the foaming chamber 50, the aforementioned steps are repeated to expose the interior of the cylindrical tube 46, and the insert 22 is pulled from the interior of the tube 46. It follows that as long as the insert 22 is positioned within the foaming chamber 50 and the perforated screens 61 and 62 (are secured in place), the insert 22 is captured between the screens 61 and 62 and thereby prevented from moving longitudinally of the gun 20.

Because the foam insert 22 is unitary in structure, it can be removed from the gun 20 as a single unit and replaced, if necessary, with an insert of like construction during servicing of the spray gun 20. The unitary structure of the insert 22 is preferable than filler material comprised of loose material, such as glass beads, because loose material requires more involved handling than a unitary structure during servicing of the spray gun. For example, glass beads are commonly removed from the gun by pouring the beads from the foaming chamber, and this action requires that the beads be carefully collected and cleaned (or replaced, if necessary) before being replaced within the foaming chamber. By comparison, the insert 20 does not require such an involved handling when removed or positioned within the foaming chamber.

Furthermore, the unitary structure of the insert 20 obviates the need to pack a filler material, such as steel wool, within the foaming chamber 50 which could lead to the packing of the filler material either too tightly or too loosely within the foaming chamber 50. If packed too tightly, the filler material could unduly obstruct the flow of foaming catalyst and gas through the foaming chamber, and if packed too loosely, the filler material might not adequately promote the mixing of the foaming catalyst and the gas as these foam-producing ingredients are conducted through the foaming chamber. By comparison, the foam insert 22 needs only to be inserted, rather than packed, within the foaming chamber 50, so that there is no need to be concerned with how tightly or how loosely the filler material is packed within the foaming chamber 50.

It will be understood that numerous modifications and substitutions can be had to the aforedescribed embodiment without departing from the spirit of the invention. For example, although the aforedescribed cartridge insert 22 has been shown and described as being cylindrical in form to substantially fill the interior of the cylindrically-shaped foaming chamber 50 (and span the circular interior of the foaming chamber 50), a cartridge insert in accordance with present invention can possess an alternative shape and size if needed to fill or span a foaming chamber possessing an alternative shape or size. Accordingly, the aforedescribed embodiment is intended for the purpose of illustration and not as limitation.

1. A filler material positionable within an apparatus for generating and injecting a foamed polymeric resin formed by the mixture of a plurality of foam-producing ingredients wherein the apparatus includes an elongate foaming chamber having an interior through which two mixable foam-producing ingredients are conducted, the filler material comprising:
a body of polyurethane foam which is adapted to be accepted by and substantially fill the interior of the foaming chamber for enhancing the blend of the mixable foam-producing ingredients as the mixable foam-producing ingredients are conducted through the foaming chamber.

2. The filler material as defined in claim 1 wherein the body of polyurethane foam is a reticulated, open-cell polyurethane foam.

3. The filler material as defined in claim 2 wherein the body of open-cell polyurethane foam possesses between about 20 and 30 pores per inch (ppi).

4. The filler material as defined in claim 1 wherein the body of polyurethane foam has a shape which substantially conforms to the shape of the interior of the foaming chamber.

5. The filler material as defined in claim 1 wherein the polyurethane foam of the body is a polyether polyurethane foam.

6. The filler material as defined in claim 1 wherein the polyurethane foam of the body possesses an Indentation Force Deflection value which is at least as great as 30 pounds per 50 square inches (30 lbs/50 in²).

7. The filler material as defined in claim 1 wherein the polyurethane foam of the body possesses a density which is between within the range of between 1.0 lbs/ft³ and 5.0 lbs/ft³.

8. A cartridge insert positionable within the foaming chamber of an apparatus for generating and injecting a foamed polymeric resin formed by the mixture of a plurality of foam-producing ingredients wherein the foaming chamber of the apparatus is elongate in form and is adapted to conduct two mixable foam-producing ingredients along the length thereof, the cartridge insert comprising:
a body of reticulated, open-cell polyurethane foam which is adapted to be accepted by and substantially fill the interior of the apparatus foaming chamber for enhancing the mix of the mixable foam-producing ingredients as the mixable foam-producing ingredients are conducted through the foaming chamber.

9. The insert as defined in claim 8 wherein the body of open-cell polyurethane foam possesses between about 20 and 30 pores per inch (ppi).

10. The insert as defined in claim 8 wherein the polyurethane foam of the body is a polyether polyurethane foam.

11. The insert as defined in claim 8 wherein the polyurethane foam of the body possesses an Indentation Force Deflection value which is at least as great as 30 pounds per 50 square inches (30 lbs/50 in²).

12. The insert as defined in claim 8 wherein the polyurethane foam of the body possesses a density which is between within the range of between 1.0 lbs/ft³ and 5.0 lbs/ft³.

13. The insert as defined in claim 8 wherein the body of open-cell polyurethane foam possesses between about 20 and 30 pores per inch (ppi), possesses an Indentation Force Deflection value which is at least as great as 30 pounds per 50 square inches (30 lbs/50 in²), and possesses a density which is between within the range of between 1.0 lbs/ft³ and 5.0 lbs/ft³.

14. The insert as defined in claim 13 wherein the polyurethane foam of the body is a polyether polyurethane foam.

15. In combination with an apparatus for generating and injecting a foamed polymeric resin formed by the mixture of a plurality of foam-producing ingredients wherein the apparatus includes an elongate foaming chamber having an interior through which two mixable foam-producing ingredients are conducted and mix together as the two foam-producing ingredients are conducted therealong, a filler material positionable within the foaming chamber comprising:
a body of polyurethane foam which is adapted to be accepted by and substantially fill the interior of the foaming chamber for promoting the blend of the mixable foam-producing ingredients as the mixable foam-producing ingredients are conducted through the foaming chamber.

16. The combination of claim 15 wherein the body of polyurethane foam of the filler material is a reticulated, open-cell polyurethane foam.

17. The combination of claim 16 wherein the body of open-cell polyurethane foam possesses between about 20 and 30 pores per inch (ppi).

18. The combination of claim 15 wherein the polyurethane foam of the body is a polyether polyurethane foam.

19. The combination of claim 15 wherein the polyurethane foam of the body possesses an Indentation Force Deflection value which is at least as great as 30 pounds per 50 square inches (30 lbs/50 in²).

20. The combination of claim 15 wherein the polyurethane foam of the body possesses a density which is between within the range of between 1.0 lbs/ft³ and 5.0 lbs/ft³.
